(19) United States
(12) Patent Application Publication
(10) Pub. No.: US 2008/0008850 A1
(43) Pub. Date: Jan. 10, 2008

(54) OPTICAL INFORMATION RECORDING MEDIUM AND METHOD FOR PRODUCING THE SAME

(76) Inventors: Takuo KODAIRA, Takasaki-shi (JP); Akio AMANO, Gunma-Gun (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/775,333

(22) Filed: Jul. 10, 2007

(30) Foreign Application Priority Data
Jul. 10, 2006 (JP) 2006-189081

(51) Int. Cl. B32B 3/02

(52) U.S. Cl. 428/64.4

(57) ABSTRACT

A uniform thin film can be formed simply through coating by using a spin-coating method, and a satisfactory optical property (high refractive index) is obtained by using a dye material (a dye composition containing a mono(aza)methine dye and a basic compound) capable of forming an H-aggregate. The mono(aza)methine dye and the basic compound, which exhibit good solubility, are used as the dye material, and thereby, a solvent that does not corrode a substrate can be employed. Consequently, an optical recording layer composed of a thin film that has formed an H-aggregate is provided, a dye thin film exhibiting a large difference in refractive index between before and after the recording can be used, wherein the decomposition of the dye is an endothermic reaction, and application on a substrate can be performed by a spin-coating method.

### BACKGROUND OF THE INVENTION

1. Field of the Invention

The present invention relates to an optical information recording medium and a method of producing the same. In particular, the present invention relates to an optical information recording medium that includes at least an optical recording layer containing a light-absorbing substance and the like, and that is usable for the optical recording layer of an optical information recording medium onto and from which writing and reproducing can be performed with a high density and at a high speed using a semiconductor laser for emitting a red laser beam having a wavelength in the range of 750 to 830 nm, a short-wavelength red laser beam having a wavelength in the range of 640 to 680 nm (for example, 650 to 665 nm), or a blue laser beam having a shorter wavelength in the range of about 350 to 500 nm (for example, about 405 nm), and a method of producing the optical information recording medium.

2. Description of the Related Art

Write-once optical recording discs, such as CD-R discs, which were developed first, and DVD-R/+R discs, which are discs having a format for large-capacity recording and were subsequently developed, include a dye thin film used as a recording layer. This dye is decomposed by high-power laser beam irradiation to change an optical property of the film, thereby performing recording. More specifically, in unrecorded portions, signal light having a high ratio of the intensity of light irradiated by a laser for reproducing and return light from a reflective film, which interfere with each other, to the intensity of the irradiated light (i.e., reflectance) is detected. On the other hand, in recorded portions, the reflectance is decreased because the refractive index of the dye is decreased by the decomposition of the dye. The weakened reflected light is detected as recording signals. Such a recording principle is generally referred to as “high-to-low recording”. This indicates that a reflectance, which is high before recording, is decreased after recording, thereby enabling signals to be recorded. In order to record information in this manner, the refractive index of a dye thin film used as a recording layer is important.

Hitherto, as examples of CD-R discs onto which and from which recording and reproducing are performed with a laser beam having a wavelength of 780 nm and DVD-R/+R discs onto which and from which recording and reproducing are performed with a laser beam having a wavelength of 660 nm, many high-to-low recording-type write-once optical recording discs based on the above principle have arrived on the market. However, among the HD DVD-R discs and the Blu-ray Disc-R discs (hereafter, these are referred to as “blue discs or the like”) onto which and from which recording and reproducing are performed with a laser beam having a wavelength of 405 nm, a high-to-low recording-type write-once optical recording disc has not yet reached a level of commercial products having practicability. This is because a dye thin film having a proper refractive index has not been obtained.

As shown in FIG. 1, an HD DVD-R (write-once HD DVD) disc 1 includes a light-transmissive substrate 2, an optical recording layer 3 (light-absorbing layer) provided on the substrate 2, a light-reflecting layer 4 provided on the optical recording layer 3, and a protective layer 5 (adhesion layer) provided on the light-reflecting layer 4. Furthermore, a dummy substrate 6 that is made of the same material as the above-described substrate 2 is laminated on the protective layer 5 as required, so that a thickness of about 1.2 mm specified as a standard is ensured.

The substrate 2 is made of a highly transparent material having a refractive index for a laser beam in the range of, for example, about 1.5 to 1.7 and excellent impact resistance. Examples of materials for the substrate 2 include resin plates, such as a polycarbonate plate, an acrylic plate, and an epoxy plate; and glass plates. A spiral pregroove 7 is provided on the above-described substrate 2. Lands 8, i.e., portions other than the pregroove 7, are provided at both sides of the pregroove 7.

The optical recording layer 3 provided on the substrate 2 is composed of a light-absorbing substance containing a dye material. When the optical recording layer 3 is irradiated with a laser beam 9, heat generation, heat absorption, melting, sublimation, deformation, or modification occurs in the optical recording layer 3. This optical recording layer 3 is formed by, for example, dissolving an azo dye, a cyanine dye, or the like into a solvent, and then uniformly applying the resulting solution on the surface of the substrate 2 by means of a spin coating method or the like.

The light-reflecting layer 4 is a metal film having a high thermal conductivity and high light reflectivity. The light-reflecting layer 4 is formed by depositing, for example, gold, silver, copper, aluminum, or an alloy thereof by a vapor deposition method, a sputtering method, or the like.

The protective layer 5 is made of a resin having an impact resistance as high as that of the substrate 2 and excellent adhesiveness. For example, the protective layer 5 is formed by applying a UV curable resin by a spin coating method and then irradiating the resin with ultraviolet rays so as to cure.

As shown in FIG. 1, when the HD DVD-R disc 1 is irradiated with the laser beam 9 (recording light) from the side of the light-transmissive substrate 2 (incident layer), the optical recording layer 3 absorbs energy of the laser beam 9, thus generating (or absorbing) heat. Consequently, a recording pit 10 is formed by thermal decomposition of the optical recording layer 3 due to this heat generation (heat absorption). Reference numerals 11, 12, 13, and 14 each indicate a boundary of adjacent layers.

As shown in FIG. 2, a Blu-ray Disc-R (write-once Blu-ray) disc 20 includes a light-transmissive substrate 2 having a thickness of 1.1 mm, a light-reflecting layer 4 provided on the substrate 2, an optical recording layer 3 (light-absorbing layer) provided on the light-reflecting layer 4, a protective layer 5 provided on the optical recording layer 3, an adhesion layer 21 provided on the protective layer 5, and a cover layer 22 having a thickness of 0.1 mm and provided on the adhesion layer 21. Recently, the cover layer 22 is sometimes provided on the protective layer 5 without forming the adhesion layer 21, so that protective layer also functions as an adhesion layer.

A spiral pregroove 7 is provided on the above-described substrate 2. Lands 8, i.e., portions other than the pregroove 7, are provided at both sides of the pregroove 7.

When the boundary between the substrate 2 and the light-absorbing layer 3 satisfies a low reflectance, the light-reflecting layer 4 need not be provided.

As shown in FIG. 2, when the Blu-ray Disc-R 20 is irradiated with a laser beam 9 (recording light) from the side of the cover layer 22 serving as a layer that allows transmittance of the laser beam therethrough, the optical recording layer 3 absorbs energy of the laser beam 9, thus generating (or absorbing) heat. Consequently, a recording pit 10 is formed by thermal decomposition of the optical recording layer 3 due to this heat generation (heat absorption). Reference numerals 23, 24, 25, and 26 each indicate a boundary of adjacent layers. In FIG. 2, the recording pit is formed on the optical recording layer 3 corresponding to the land 8. Alternatively, recently, the recording pit is often formed on the optical recording layer 3 corresponding to the pregroove 7.

In high-speed recording on the HD DVD-R disc 1 or the Blu-ray Disc-R disc 20 having the above structure, it is necessary to perform predetermined recording within a time shorter than the time required for a known recording speed or a low-speed recording. Therefore, a recording light power is increased, thereby increasing the quantity of heat generated in the optical recording layer 3 or the quantity of heat per unit time during recording. Consequently, a thermal strain problem easily occurs, resulting in variations among the recording pits 10. In addition, the output power of a semiconductor laser for emitting the laser beam 9 is limited. Accordingly, a highly sensitive dye material that can be used for high-speed recording has been desired.

In the known write-once optical information recording media, such as CD-R and DVD-R discs, a great importance is placed on the formation of a recording pit by changing the refractive index due to decomposition and denaturation of an organic compound used for an optical recording layer, and it is important to select a material that has an appropriate optical constant and that exhibits an appropriate decomposition behavior. However, in such an organic compound optimized in a known write-once optical information recording medium, optical properties (in particular, refractive index) for a blue laser wavelength, e.g., 405 nm, are normally mediocre. In order that an organic compound has a laser beam absorption band in the vicinity of the blue laser wavelength, as regards a cyanine dye having a methine chain, it is necessary to decrease the length of the molecular skeleton or decrease the length of the conjugated system. However, in this case, the absorption coefficient, that is, the refractive index, is decreased and, therefore, a high degree of modulation cannot be achieved during reproducing.

The term “highly sensitive dye material” means that the dye has an appropriate refractive index. In order to achieve this, the refractive index (n) must be high and the extinction coefficient (k) must be low. However, in order to achieve this, the dye must have a high absorptivity and the full width at half maximum of the absorption spectrum must be small.

It is generally known that as the maximum adsorption wavelength (λₘₐₓ) is decreased, the molar absorptivity (ε) is decreased, and it is believed to be difficult to develop a dye that can be used to realize high-to-low-type optical recording discs for a short recording wavelength, which is used for the blue discs or the like.

There are some dyes that can be practically used for low-to-high-type recording, which has a recording property inverse to that of high-to-low-type recording. However, in high-speed recording, the calorific value due to the decomposition of a dye is high. Therefore, high-quality recording cannot be performed because of thermal interference resulting in, for example, the recording pits becoming enlarged. Accordingly, a dye whose calorific value during its decomposition is low has been desired.

As described above, an optical information recording medium has also been developed, onto and from which recording and reproducing can be performed using a blue laser beam having a wavelength in the range of about 350 to 500 nm (e.g., about 405 nm) that is shorter than the wavelength of a commonly used laser beam. Regarding an organic dye compound used for an optical recording layer, as the wavelength of the laser beam is decreased, it is necessary to form a thinner film serving as the optical recording layer and to obtain a high refractive index. In order to achieve the high refractive index, the dye must have a high absorptivity, and the full width at half maximum of the absorption spectrum must be small.

As described above, there are few materials having a high molar absorptivity (ε) for a blue laser beam. Accordingly, in order to increase the refractive index of the optical recording layer 3, it is important to control the full width at half maximum, which relates to the degree of aggregation of dye molecules when a dye film is formed.

FIG. 3 shows the relationship between the full width at half maximum (full width at half maximum (degree of aggregation)/cm⁻¹) of an absorption spectrum and the refractive index (n max). As is clear from this relationship, a material having a high refractive index can be ensured by using a material that shows an appropriate full width at half maximum.

From this point of view, the use of an aggregation state, in particular, the J-aggregation, of dye molecules has been studied. In the state of the J-aggregation, dye molecules are arrayed in a edge-to-edge manner. It is known that when this J-aggregation occurs, a peak of an optical absorption spectrum becomes sharper, the full width at half maximum of the peak is decreased, and the peak is shifted to the long-wavelength side.

Examples of known technologies for forming a J-aggregate thin film include a Langmuir-Blodgett method (LB method), a dip method, and a spin-coating method.

In the LB method, when molecules having both a hydrophilic group and a hydrophobic group are dissolved into a proper solvent and the solution is then spread on the water surface, the molecules are adsorbed on the gas-liquid interface to form a monomolecular film on the water surface. Subsequently, for example, a substrate or the like is gradually immersed therein and, thereby, a uniform thin film is formed. A precise and uniform thin film can be formed by the LB method and a thin film having excellent optical properties can be produced. However, since skilled control is necessary during the formation of the film, this method is disadvantageous in terms of time and cost.

In the dip method, a substrate is immersed in a dye solution, then is pulled out from the solution, and is dried, thereby forming a dye film on the surface of the substrate. In the dip method, aggregation can be easily controlled. However, the dip method is disadvantageous in that it is difficult to form a uniform thin film and stably maintain the thin film.

In the spin-coating method, a coating solution is applied dropwise on a substrate while the substrate is rotated, and coating solution is spread by the centrifugal force. A thin film can be relatively easily formed by the spin-coating method. However, since molecules are present in various status under a simple coating condition, it is difficult to control the aggregation. This spin-coating method is superior to the other methods in view of simplicity and ease of the process, and is widely employed in the process for producing optical information recording media, such as CD-R and DVD-R discs.

Examples of J-aggregate thin films prepared by the spin-coating method or a similar method of forming a thin film include the following films.

Japanese Unexamined Patent Application Publication No. 2000-199919 discloses a method of forming a J-aggregate thin film of an organic dye (cyanine dye). More specifically, a J-aggregate thin film is formed using a sol solution containing a cyanine dye and silica.

In this technique, satisfactory dye physical properties as a dye thin film used for an optical information recording medium cannot be obtained because the concentration of the cyanine dye in the thin film is decreased by the silica. Therefore, the dye thin film is not suitable for use in an optical information recording medium. That is, it is difficult to apply this technique to an optical information recording medium.

Japanese Unexamined Patent Application Publication No. 2000-151904 discloses a method of forming a J-aggregate thin film of an organic dye (cyanine dye). More specifically, a high-viscosity solution containing a cyanine dye and a polymer material is subjected to a rubbing treatment to prepare a J-aggregate thin film.

In this technique, satisfactory dye physical properties as a dye thin film used for an optical information recording medium cannot be obtained because the concentration of the cyanine dye in the thin film is decreased by the polymer material. Therefore, the dye thin film is not suitable for use in an optical information recording medium. Furthermore, when heat (temperature: 130° C.) required for the rubbing treatment is applied to the polycarbonate substrate 2, the shape of the substrate 2 is changed. That is, it is difficult to apply this technique to an optical information recording medium.

Japanese Unexamined Patent Application Publication No. 2001-305591 discloses a method of forming a J-aggregate thin film of an organic dye (squarylium dye). More specifically, a squarylium dye, which is easily formed into a J-aggregate thin film, is used and applied by a spin-coating method to form a J-aggregate thin film.

The technique disclosed in this patent document is disadvantageous in that the squarylium dye has poor solubility in organic solvents. Accordingly, it is difficult to ensure the solubility in a solvent that does not corrode the polycarbonate, which is a material of the substrate 2 of the optical information recording medium. That is, it is difficult to obtain a sufficient thickness required for a dye thin film used for an optical information recording medium. When the squarylium dye molecules are chemically modified with an appropriate substituent in order to ensure the solubility, this chemical modification affects the formation of the J-aggregate thin film. Accordingly, the design becomes complicated because both the solubility and the degree of aggregation must be considered. That is, it is difficult to apply this technique to an optical information recording medium.

According to Japanese Patent No. 3429521, an LB film is used as a material of the optical recording layer 3. More specifically, an optical information recording medium is proposed, in which a dye film containing a photochromic dye is formed on a substrate 2. This substrate 2 is a ceramic substrate that radiates far-infrared rays. This patent document discloses the optical information recording medium in which the above photochromic material is an aggregate of dye molecules, and is a spiropyran J-aggregate thin film. A chloroform solution prepared by mixing different types of cyanine dyes and a specific fatty acid in an appropriate mixing ratio is spread on a water surface and compressed to form a monomolecular film in which the molecular orientation is controlled. This monomolecular film is adhered on the substrate 2 to form a dye coating film containing the photochromic dye.

In this technique, a substrate is prepared by subjecting the surface of a non-fluorescent glass substrate to a hydrophobic treatment with trimethylchlorosilane. The above molecular-orientation-controlled monomolecular films are adsorbed on the substrate by a vertical immersion method so that 20 layers are accumulated on one side of the substrate. However, it is difficult to obtain a sufficient thickness required for a dye thin film used for an optical information recording medium in practice. In addition, it is very difficult to apply the LB method to the current optical information recording medium.

J-aggregate thin films can have a high refractive index and are useful for the optical recording layer 3 of the HD DVD-R disc 1 and the Blu-ray Disc-R disc 20. However, at present, a simple preparation method, in which aggregation can be easily controlled, has not yet been established. The J-aggregate thin films can be relatively easily prepared by the LB method or the dip method, but these methods are disadvantageous in that skilled control is necessary or a uniform thin film cannot be stably obtained. On the other hand, although thin films can be easily formed by the spin-coating method, it is difficult to prepare J-aggregate thin films by the spin-coating method.

### SUMMARY OF THE INVENTION

At least one embodiment of the present invention has been conceived in view of the above problems, and an object of at least one embodiment of the present invention is to provide an optical information recording medium in which optical properties can be improved by directly forming an H-aggregate of a mono(aza)methine compound dye that can provide a uniform thin film containing an H-aggregate of dye molecules without disposing other auxiliary means, and a method for producing the same.

An object of at least one embodiment of the present invention is to provide an optical information recording medium, in which a thin film having a high refractive index and satisfactory optical properties can be formed, and a method for producing the same.

An object of at least one embodiment of the present invention is to provide an optical information recording medium, in which an optical recording layer containing an H-aggregate can be formed by a simple method (spin-coating method), and a method for producing the same.

An object of at least one embodiment of the present invention is to provide an optical information recording medium, in which a dye material can be applied using a solvent that does not corrode a substrate material, such as polycarbonate, and a method for producing the same.

An object of at least one embodiment of the present invention is to provide an optical information recording medium, in which a component in a thin film of the optical recording layer is mainly composed of a dye material, which is suitable for high-speed recording and high-density recording, and which has high sensitivity and an excellent short-mark recording ability, and a method for producing the same.

As a result of intensive studies, the present inventors found the following. In the known CD-R and DVD-R/+R discs, an amorphous thin film of dye molecules is used, and the dye molecules are randomly oriented in the amorphous thin film. In the thin film in which the molecules are randomly oriented, intermolecular interaction is weak and the thin film shows a broad absorption spectrum. In contrast, in an H-aggregate, molecules form a minute molecular aggregate while being regularly arrayed by intermolecular interaction. Therefore, the absorption spectrum has a small full width at half maximum, and the absorbance is larger than that in the case where molecules are randomly oriented. As a result of intensive studies, by preparing an H-aggregate thin film, a dye thin film having a high refractive index n and a low extinction coefficient k was able to be formed. Consequently, a high-to-low optical information recording medium was able to be realized. Furthermore, when recording was performed by breaking an aggregate by irradiation of a recording laser beam, the quantity of heat generated by the decomposition was decreased and thermal interference was suppressed.

The J-aggregate has been known for a long time. As described above, the J-aggregate has been formed in a solution with a high concentration, or a method of allowing molecules to be forcibly oriented, e.g., a method of preparing an LB film, has been employed. Therefore, the J-aggregate cannot be used for optical recording discs for practical use. However, recently, for example, by substituting terminals of two N-alkyl chains of an indolenine cyanine dye with sulfonic acid groups, it has become possible to form a J-aggregate thin film by a spin-coating method (Japanese Unexamined Patent Application Publication No. 2005-74872 and Japanese Patent Application No. 2004-101442 (by the applicant of the present invention)). A least one embodiment of the present invention focuses on the points that, for example, a uniform thin film (e.g., a thickness of about 10 nm to about 500 nm) can be simply formed by a spin-coating method using mono(aza)methine compound dyes; a satisfactory optical property (high refractive index (e.g., about 1.6 to about 2.4) and/or low extinction coefficient k (e.g., about 0.01 to about 0.3)) is achieved using a dye material that can form an H-aggregate by addition of a basic compound; a mono(aza)methine compound (mono(aza)methine cyanine) containing an oxazole nucleus or thiazole nucleus and having satisfactory solubility is used as the above dye material and, thereby, a solvent that does not corrode a substrate can be used; and thus, dyes in which a large difference in the refractive index before and after recording can be achieved and which are decomposed by an endothermic reaction can be used.

A least one embodiment of the present invention provides (1) an optical information recording medium including an optical recording layer onto which information is to be recorded by a laser beam, wherein the optical recording layer includes a dye film containing a mono(aza)methine compound represented by the following general formula [1] and a basic compound and is directly provided on a surface of a layer that allows transmittance of the laser beam therethrough, the surface being arranged opposite a surface of the layer through which the above-described laser beam enters:

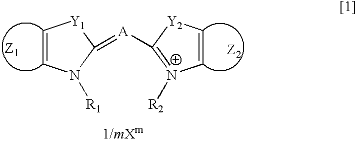

(wherein Z₁ and Z₂ each represent an atomic group required for forming a five- or six-membered aromatic ring or a five- or six-membered nitrogen-containing heterocyclic ring, Z₁ and Z₂ may be the same or different, and each of Z₁ and Z₂ may have a substituent; Y₁ and Y₂ each represent one selected from the group consisting of O, S, N—R (wherein R represents an alkyl group of (CH₂)ₙCH₃ (wherein n represents an integer selected from 0 to 5)), and CH═CH, and Y₁ and Y₂ may be the same or different; A represents CH or N; R₁ and R₂ each represents (CH₂)ₙW (wherein n represents an integer selected from 0 to 5 and W is selected from CH₃, SO₃⁻, and COO⁻), and R₁ and R₂ may be the same or different; and 1/m X^{m} (wherein m of 1/m represents an integer selected from 1 to 4 and m of X^{m} represents the selected number of positive or negative charge) represents at least one type selected from the group consisting of an organic ion, an inorganic ion, and an organometallic ion, and 1/m X^{m} may not be contained when one of R₁ and R₂ represents (CH₂)ₙSO₃⁻ or (CH₂)ₙCOO⁻ (wherein n represents an integer selected from 0 to 5)).

Furthermore, at least one embodiment of the present invention provides (2) the optical information recording medium according to the above item (1), wherein the mono(aza)methine compound represented by the above general formula [1] is a mono(aza)methine compound represented by the following general formula [2]:

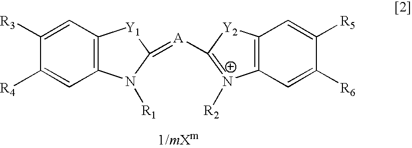

(wherein Y₁ and Y₂ each represent one selected from the group consisting of O, S, N—R (wherein R represents an alkyl group of (CH₂)ₙCH₃ (wherein n represents an integer selected from 0 to 5)), and CH═CH, and Y₁ and Y₂ may be the same or different; A represents CH or N; R₁ and R₂ each represent (CH₂)ₙW (wherein n represents an integer selected from 0 to 5 and W is selected from CH₃, SO₃⁻, and COO⁻), and R₁ and R₂ may be the same or different; 1/m X^{m} (wherein m of 1/m represents an integer selected from 1 to 4 and m of X^{m} represents the selected number of positive or negative charge) represents at least one type selected from the group consisting of an organic ion, an inorganic ion, and an organometallic ion, and 1/m X^{m} may not be contained when one of R₁ and R₂ represents (CH₂)ₙSO₃⁻ or (CH₂)ₙCOO⁻ (wherein n represents an integer selected from 0 to 5); and R₃ to R₆ each represent one selected from the group consisting of a hydrogen atom, a linear or branched aliphatic hydrocarbon group, such as an alkyl group of (CH₂)ₙCH₃ (wherein n represents an integer selected from 0 to 5), a halogenated aliphatic hydrocarbon group, such as a halogenated alkyl group, a halogen atom, an ether group, such as an alkoxy group, an ester group, an alkylsulfamoyl group, a nitro group, a cyano group, an aromatic ring, and a heterocyclic ring, each of R₃ to R₆ may have a substituent, and R₃ to R₆ may be the same or different), (3) the optical information recording medium according to the above item (1) or (2), wherein the basic compound is a hydroxide of a quaternary amine, and the molar ratio of OH to the mono(aza)methine dye is 0.2 to 3 (including 0.5, 1, 1.5, 2, 2.5, and values between any two numbers of the foregoing), (4) the optical information recording medium according to the above item (3), wherein the hydroxide of the quaternary amine is tetraalkylammonium hydroxide, (5) the optical information recording medium according to any one of the above items (1) to (4), wherein the dye film is an H-aggregate of the mono(aza)methine compound represented by the above general formula [1] or [2], (6) The optical information recording medium according to any one of the above items (1) to (5), wherein the laser beam has a wavelength in the range of 350 to 500 nm, (7) a method of producing an optical information recording medium including an optical recording layer onto which information is to be recorded by a laser beam, the method including the step of applying a coating solution of a mono(aza)methine dye composition containing a dye of a mono(aza)methine compound represented by the above general formula [1] or [2] and a basic compound by a spin-coating method to form the above optical recording layer, (8) the method of producing an optical information recording medium according to the above item (7), wherein the mono(aza)methine dye forms an H-aggregate, and (9) the method of producing an optical information recording medium according to the above item (7) or (8), wherein a fluorinated alcohol, such as 2,2,3,3-tetrafluoro-1-propanol, is used as a solvent for dissolving the mono(aza)methine compound. In an embodiment, the concentration of the mono(aza)methine compound may be in the range of about 5 to about 40 g/L.

The above-described mono(aza)methine dye compound, the composition containing this compound and the basic compound, the optical information recording medium including them, and the production method thereof can be applied not only to recording and reproducing using a blue laser beam, but also to CD and DVD discs for recording and reproducing.

Methods of synthesizing the above-described mono(aza)methine dye compound include, but are not limited to, a method of synthesizing an oxazole nucleus-containing mono(aza)methine compound (Japanese Unexamined Patent Application Publication No. 10-60295), and a method of synthesizing a compound containing a thiazole nucleus or a quinoline nucleus as a heterocyclic ring (Great Britain Patent No. 447,038). A method of synthesizing a monomethine cyanine compound is also described in PCT Publication No. WO 2005/095521A1 (PCT/JP2005/006724), and this method can be employed. In the identification, a method of identifying a mono(aza)methine cyanine compound by using an NMR analyzer, a GC/MS analyzer, and the like can be referred to.

In the optical information recording medium according to at least one embodiment of the present invention and the method of producing the same, the optical recording layer includes a dye film containing a specific dye material of the mono(aza)methine compound represented by the above general formula [1] or [2] and a basic compound. Accordingly, a uniform thin film containing an H-aggregate of the dye molecules can be formed even by a simple spin-coating method. When the H-aggregation occurs, a thin film exhibiting an absorption peak at a wavelength shorter than 400 nm and having a high refractive index can be formed. Accordingly, thermal decomposition can be performed by the light absorption derived from the H-aggregation of dye molecules in such a way that the aggregation of the aggregated dye is broken. Consequently, the heat generation due to decomposition can be reduced, and a difference in the refractive index before and after recording can be easily generated. Furthermore, since this thermal decomposition of the H-aggregate of the dye is an endothermic reaction, control of heat dissipation, which is required in a known case of an exothermic reaction, need not be performed.

That is, a recording material thin film having excellent optical properties, such as a high refractive index and a large difference in the refractive index before and after recording, and a thermal property corresponding to an endothermic reaction can be uniformly formed. In addition, the above-described aggregate thin film is formed by a simple spin-coating method, and thus, an optical information recording medium having excellent properties can be produced without changing a known process.

Furthermore, by using a mono(aza)methine dye compound having satisfactory solubility, the dye material can be applied on a substrate using a solvent, such as 2,2,3,3-tetrafluoro-1-propanol (TFP), which does not corrode the substrate.

For purposes of summarizing the invention and the advantages achieved over the related art, certain objects and advantages of the invention are described in this disclosure. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

Further aspects, features and advantages of this invention will become apparent from the detailed description of the preferred embodiments which follow.

### BRIEF DESCRIPTION OF THE DRAWINGS

These and other features of this invention will now be described with reference to the drawings of preferred embodiments which are intended to illustrate and not to limit the invention. The drawings are oversimplified for illustrative purposes and are not to scale.

FIG. 1 is an enlarged cross-sectional view of the relevant part of a general disc-shaped optical information recording medium (HD DVD-R disc).

FIG. 2 is an enlarged cross-sectional view of the relevant part of another general disc-shaped optical information recording medium (Blu-ray Disc-R disc).

FIG. 3 is a graph showing the relationship between the full width at half maximum of an absorption spectrum and the refractive index.

FIG. 4 is a graph showing the results of spectral measurement of a solution prepared by adding tetramethylammonium hydroxide to Compound I (formula [9]) and thin films each prepared by applying the solution (on a single plate).

FIG. 5 is a graph showing the results of spectral measurement of thin films each prepared by applying a solution containing Compound X (formula [10]) and tetramethylammonium hydroxide (on a single plate).

FIG. 6 is a graph showing the results of spectral measurement of a thin film prepared by applying a solution containing Compound II (formula [11]) and tetramethylammonium hydroxide (on a single plate).

FIG. 7 is a graph showing the results of spectral measurement of a thin film prepared by applying a solution containing Compound III (formula [12]) and tetramethylammonium hydroxide (on a single plate).

FIG. 8 is a graph showing the results of spectral measurement of a thin film prepared by applying a solution containing Compound IV (formula [13]) and tetramethylammonium hydroxide (on a single plate).

FIG. 9 is a graph showing the results of spectral measurement of a thin film prepared by applying a solution containing Compound V (formula [14]) and a base represented by formula [15] (on a single plate).

FIG. 10 is a graph showing the results of spectral measurement of a thin film prepared by applying a solution containing Compound VI (formula [16]) and a base represented by formula [17] (on a single plate).

### DESCRIPTION OF THE PREFERRED EMBODIMENTS

In at least one embodiment of the present invention, a thin film containing an H-aggregate is formed using a mono(aza)methine dye composition prepared by adding a basic compound to a mono(aza)methine compound represented by the above general formula [1] or [2]. Accordingly, optical information recording media (an HD DVD-R disc 1 and a Blu-ray Disc-R disc 20) each having a uniform optical recording layer with a high refractive index can be realized using a solution or a dispersion liquid containing the dye composition by a simple spin-coating method.

In the mono(aza)methine compound (mono(aza)methine cyanine dye) represented by the above general formula [1] or [2], when A in the molecular (dye) skeleton is CH, the compound is a monomethine cyanine dye, and when A in the molecular (dye) skeleton is N, the compound is a mono(aza)methine cyanine dye. For example, when at least one of Y₁ and Y₂ is O, the compound includes an oxazole nucleus. When at least one of Y₁ and Y₂ is S, the compound includes a thiazole nucleus. When at least one of Y₁ and Y₂ is N, the compound includes an imidazole nucleus. When at least one of Y₁ and Y₂ is CH═CH, the compound includes a pyridine nucleus. Y₁ and Y₂ may be the same or different. Accordingly, the compound has a structure in which these nuclei are bonded by a monomethine chain or a monoazomethine chain (—N═) and is referred to as a mono(aza)methine cyanine compound (mono(aza)methine cyanine dye).

In the above general formulae [1] and [2], 1/m X^{m} represents at least one type selected from the group consisting of an organic ion, an inorganic ion, and an organometallic ion. When X^{m} has m negative charges (m−), X^{m} represents at least one type selected from the group consisting of an organic anion, an inorganic anion, and an organometallic anion, wherein m represents an integer of 1 to 4. When m is 1, the anion has a single negative charge. When m is 2 to 4, the anion has m negative charges. In such a case, the number of charges of the anion may be multiplied by 1/m so as to correspond to a single negative charge. Specific examples of the organic anion include anions of alkyl carboxylic acids, such as CH₃COO⁻, trifluoromethyl carboxylic acid (CF₃COO⁻), alkylsulfonic acid, such as CH₃SO₃⁻, benzenesulfonic acid (φ-SO₃⁻, wherein φ represents a benzene ring, hereafter the same), toluenesulfonic acid (H₃C-φ-SO₃⁻), and benzenecarboxylic acid (φ-COO⁻). Specific examples of the inorganic anion (negative ion) include halogen atom ions (Cl⁻, Br⁻, and I⁻); PF₆⁻; SbF₆⁻; anions of phosphoric acid, perchloric acid (ClO₄⁻), periodic acid, and fluoroboric acid (BF₄⁻); NO₃⁻; OH⁻; SCN⁻; and anions of tetraphenylboric acid and tungstic acid. When X^{m} has m positive charges (m+), X^{m} represents at least one type selected from the group consisting of an organic cation, an inorganic cation, and an organometallic cation. An example of them includes a quaternary amine. Specific examples thereof include ammonium, monoalkylammonium to tetraalkylammonium, and monoalkylammonium to tetraalkylammonium in which a phenyl group has substituted for entire or a part of alkyl groups. When one of R₁ and R₂ represents (CH₂)ₙSO₃⁻ or (CH₂)ₙCOO⁻ (wherein n represents an integer selected from 0 to 5), 1/m X^{m} may not be contained.

In the above general formula [1], Z₁ and Z₂ each represent an atomic group required for forming a five- or six-membered aromatic ring or a five- or six-membered nitrogen-containing heterocyclic ring (i.e., forming any one of cyclic groups selected from a five-membered aromatic ring, a six-membered aromatic ring, a five-membered nitrogen-containing heterocyclic ring, and a six-membered nitrogen-containing heterocyclic ring). Z₁ and Z₂ may be the same or different. Z₁ or Z₂ may have a substituent.

Examples of the above aromatic rings include a substituted or unsubstituted benzene ring or a substituted or unsubstituted naphthalene ring. Z₁ represents any one of four atomic groups represented by the following general formula [3]. Z₂ represents any one of four atomic groups represented by the following general formula [4]. Z₁ and Z₂ may be the same or different (wherein D₁ and D₂ each represent a substituent selected from the group consisting of a hydrogen atom, an alkyl group, an alkoxyl group, a hydroxyl group, a halogen atom, a carboxyl group, an alkoxycarbonyl group, an alkylcarboxyl group, an alkylhydroxyl group, an aralkyl group, an alkenyl group, an alkylamido group, an alkylamino group, an alkylsulfoneamido group, an alkylcarbamoyl group, an alkylsulfamoyl group, an alkylsulfonyl group, a phenyl group, a cyano group, an ester group, a nitro group, an acyl group, an allyl group, an aryl group, an aryloxy group, an alkylthio group, an arylthio group, a phenylazo group, a pyridinoazo group, an alkylcarbonylamino group, a sulfonamide group, an amino group, an alkylsulfone group, a thiocyano group, a mercapto group, a chlorosulfone group, an alkylazomethine group, an alkylaminosulfone group, a vinyl group, and a sulfone group. D₁ and D₂ may be the same or different, and p and q each represent the number of substituents and each represent an integer of 1 or more).

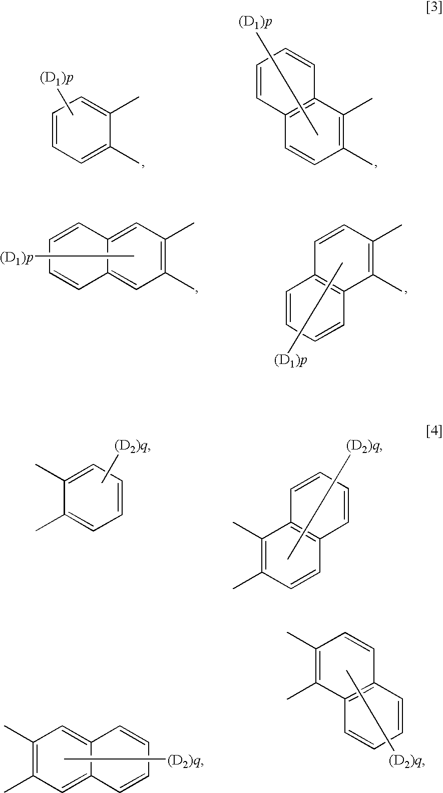

In the above general formula [2], each of R₃, R₄, R₅, and R₆ is selected from the group consisting of a hydrogen atom, a halogen atom, an alkoxy group, a cyano group, a halogenated alkyl group, a phenyl group having a substituent, and an alkyl group of (CH₂)ₙCH₃ (wherein n represents an integer selected from 0 to 5). Furthermore, each of R₃, R₄, R₅, and R₆ may be selected from the group consisting of other aromatic rings and heterocyclic rings. The selected one may have a substituent. R₃, R₄, R₅, and R₆ may be the same or different. However, at least one of R₃ to R₆ may be a Cl group. Also, the benzene rings disposed at both sides of the mono(aza)methine chain may have Cl groups symmetrically.

More specifically, in the above general formula [2], at least one of R₃ to R₆ may be substituted with a substituent. Examples of the substituent include aliphatic hydrocarbon groups, such as a methyl group, an ethyl group, a propyl group, an isopropyl group, a butyl group, an isobutyl group, a sec-butyl group, a tert-butyl group, a pentyl group, an isopentyl group, a neopentyl group, and a tert-pentyl group; halogenated aliphatic hydrocarbon groups, such as halogenated alkyl groups; ether groups, such as a methoxy group, a trifluoromethoxy group, an ethoxy group, a propoxy group, an isopropoxy group, a butoxy group, a tert-butoxy group, a pentyloxy group, a phenoxy group, and a benzyloxy group; ester groups, such as a methoxycarbonyl group, a trifluoromethoxycarbonyl group, an ethoxycarbonyl group, a propoxycarbonyl group, an acetoxy group, a trifluoroacetoxy group, and a benzyloxy group; alkylsulfonyl groups, such as a methylsulfonyl group, an ethylsulfonyl group, a propylsulfonyl group, an isopropylsulfonyl group, a butylsulfonyl group, a tert-butylsulfonyl group, and a pentylsulfonyl group; alkylsulfamoyl groups, such as a methylsulfamoyl group, a dimethylsulfamoyl group, an ethylsulfamoyl group, a diethylsulfamoyl group, a propylsulfamoyl group, a dipropylsulfamoyl group, a butylsulfamoyl group, a dibutylsulfamoyl group, a pentylsulfamoyl group, and a dipentylsulfamoyl group; halogen groups, such as a fluoro group, a chloro group, a bromo group, and an iodo group; a nitro group; and a cyano group. Each of R₃ to R₆ may have at least one substituent. All of or a part of R₃ to R₆ may be the same or different. It is desirable that each of the aromatic rings is a monocyclic benzene ring (may also be a phenyl group which may have a substituent), and each of the heterocyclic rings has at least one heteroatom selected from a nitrogen atom, an oxygen atom, a sulfur atom, a selenium atom, and a tellurium atom. The aromatic rings and the heterocyclic rings may be the same or different between (R₃, R₄) and (R₅, R₆), and each of the rings may have at least one substituent.

These aromatic rings and the heterocyclic rings may have at least one substituent. Examples thereof include aliphatic hydrocarbon groups, such as a methyl group, an ethyl group, a propyl group, an isopropyl group, a butyl group, an isobutyl group, a sec-butyl group, a tert-butyl group, a pentyl group, an isopentyl group, a neopentyl group, a tert-pentyl group, a 1-methylpentyl group, a 2-methylpentyl group, a hexyl group, an isohexyl group, and a 5-methylhexyl group; alicyclic hydrocarbon groups, such as a cyclopropyl group, a cyclobutyl group, a cyclopentyl group, a cyclohexyl group, and a cyclohexenyl group; aromatic hydrocarbon groups, such as a phenyl group, a biphenylyl group, an o-tolyl group, a m-tolyl group, a p-tolyl group, an o-cumenyl group, m-cumenyl group, p-cumenyl group, a xylyl group, a mesityl group, a styryl group, a cinnamoyl group, and a naphthyl group; ester groups, such as a methoxycarbonyl group, an ethoxycarbonyl group, a propoxycarbonyl group, an acetoxy group, and a benzoyloxy group; substituted or unsubstituted aliphatic, alicyclic, or aromatic amino groups, such as a primary amino group, a methylamino group, a dimethylamino group, an ethylamino group, a diethylamino group, a propylamino group, a dipropylamino group, an isopropylamino group, a diisopropylamino group, a butylamino group, and a dibutylamino group; alkylsulfamoyl groups, such as a methylsulfamoyl group, a dimethylsulfamoyl group, an ethylsulfamoyl group, a diethylsulfamoyl group, a propylsulfamoyl group, a dipropylsulfamoyl group, an isopropylsulfamoyl group, a diisopropylsulfamoyl group, a butylsulfamoyl group, and a dibutylsulfamoyl group; a carbamoyl group; a carboxyl group; a cyano group; a nitro group; a hydroxyl group; a sulfo group; a sulfoamino group; and a sulfonamide group.

In the mono(aza)methine compounds (mono(aza)methine cyanine dyes) represented by the above general formula [1] or [2], when cis/trans structural isomers are present, both isomers are included in at least one embodiment of the present invention.

More specifically, in addition to compounds described in examples described below, monomethine cyanine compounds represented by the following formulae [5] to [8] are also included in at least one embodiment of the present invention.

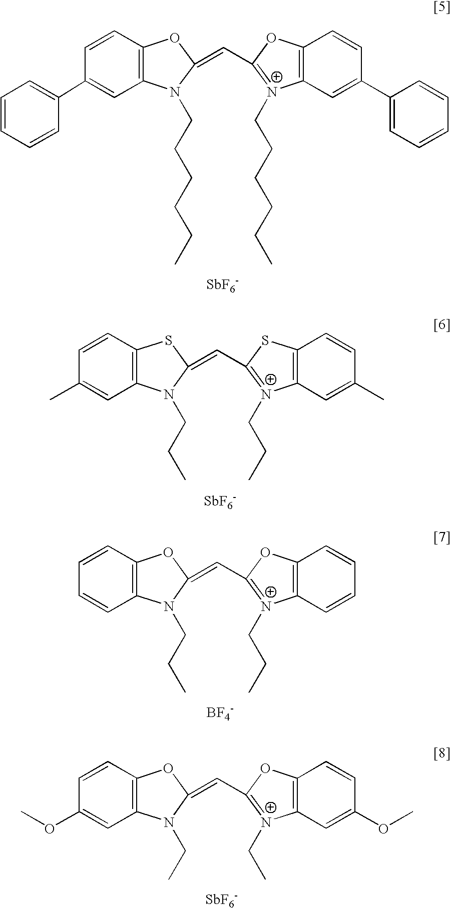

A mono(aza)methine compound represented by the above general formula [1] or [2], or any of the specific compounds that are described above or below and that belong to general formula [1] or [2], a basic compound, and a solvent are selected. A dye composition containing the former two components or a dye composition containing these three components is prepared in the form of a solution or a dispersion liquid, and a thin film containing an H-aggregate of the mono(aza)methine compound can be easily formed by a spin-coating method.

Examples of the basic compound to be added include hydroxides of quaternary amines, more specifically, ammonium hydroxide, tetraalkylammonium hydroxide (the alkyl group includes lower alkyl groups, such as a methyl group, and a plurality of alkyl groups may be the same or different), and compounds to be used in the examples described below, although not limited to them.

The molar ratio of OH⁻ (one hydroxide ion) in the basic compound to one molecule of the mono(aza)methine compound represented by the above general formula [1] or [2], or any of the specific compounds that are described above or below and that belong to general formula [1] or [2] is preferably in the range of 0.2 to 3, and more preferably, in the range of 1 to 3.

A fluorinated alcohol, such as 2,2,3,3-tetrafluoro-1-propanol, is preferably used as the solvent. However, other solvents, such as chloroform, dichloroethane, methyl ethyl ketone, dimethylformamide, methanol, toluene, cyclohexanone, acetylacetone, diacetone alcohol, cellosolves, e.g., methyl cellosolve, and dioxane, may be used alone or in combinations to the extent that a substrate is not corroded. At least one of these solvents may be used in combination with a fluorinated alcohol.

By using such a dye material that forms an H-aggregate, the refractive index of the optical recording layer 3 can be increased, the thickness of the optical recording layer 3 can be easily decreased, a high degree of modulation can be ensured, and optical information recording media 1 and 20 having excellent recording properties over a wavelength range of about 350 to 500 nm can be produced. More specifically, by breaking the H-aggregate during recording, the difference in the refractive index before and after recording is ensured, and the recording sensitivity can be improved.

Thermal decomposition of general dyes is conducted by an exothermic reaction, whereas thermal decomposition in the H-aggregate state of the mono(aza)methine compound used in at least one embodiment of the present invention is conducted by an endothermic reaction. Therefore, heat dissipation during decomposition can be suppressed.

In the present disclosure where conditions and/or structures are not specified, the skilled artisan in the art can readily provide such conditions and/or structures, in view of the present disclosure, as a matter of routine experimentation.

Also, in the present disclosure, the numerical numbers applied in embodiments can be modified by 50% in other embodiments, and the ranges applied in embodiments may include or exclude the endpoints.

### EXAMPLES

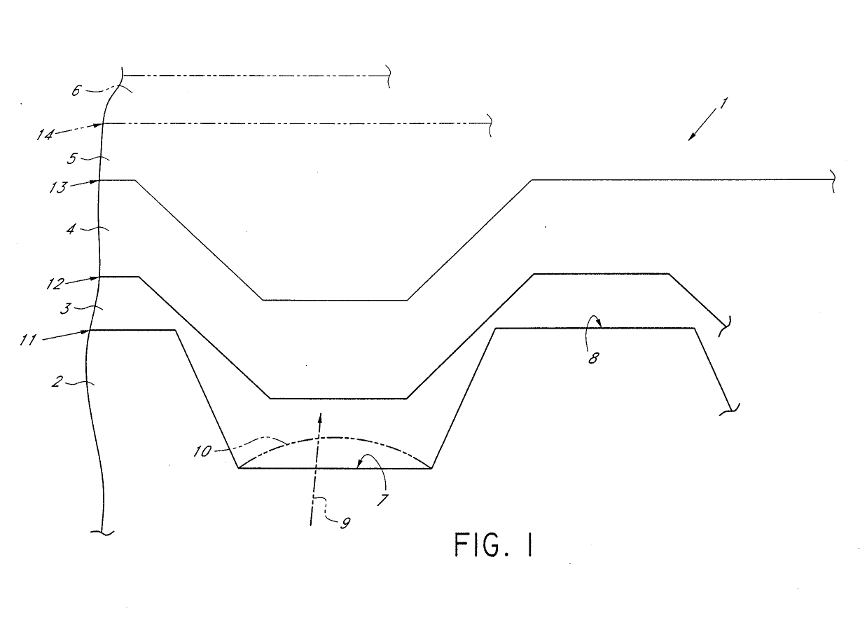

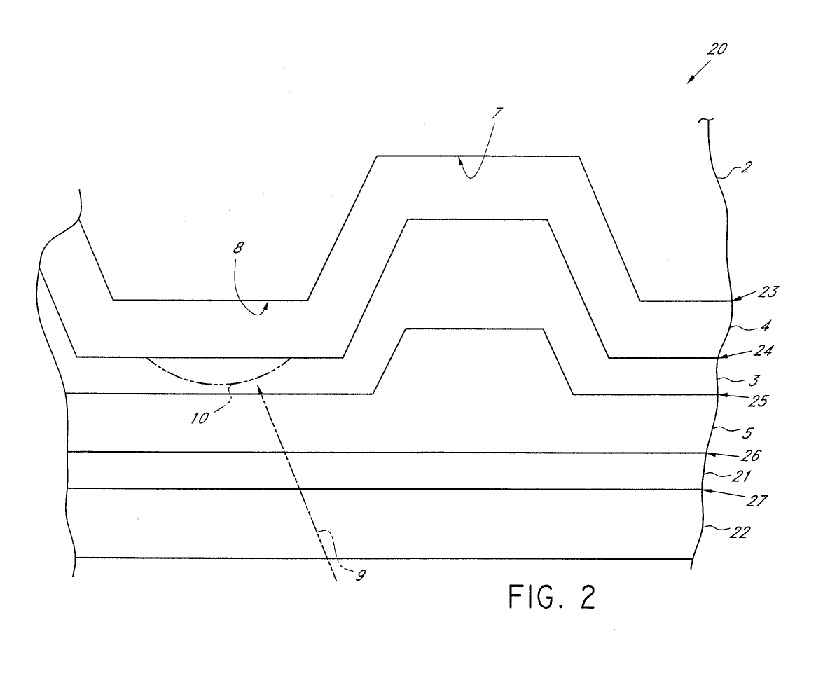

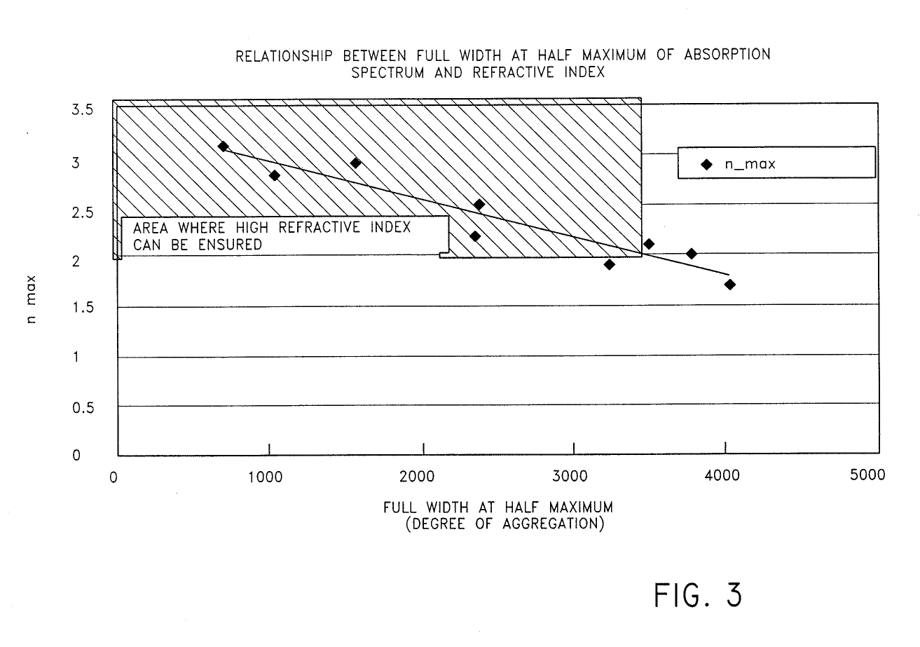

Dye materials for an optical information recording medium, optical information recording media including the dye materials, and methods of producing the optical information recording medium according to examples of the present invention will now be described with reference to the drawings. The same parts as those in FIG. 1 and FIG. 2 are assigned the same reference numerals, and a detailed description of those parts is omitted.

### Example 1

First, 2.0 g (3.8 mmol because the molecular weight is 531.81) of monomethine cyanine compound (Compound I) represented by formula [9] below was fed into a 100-mL volumetric flask. A 10-% methanol solution of tetramethylammonium hydroxide (9.1 mol/L) was then added in an amount of 0 times (without addition), 1 times (0.42 mL) (more specifically, the molar ratio of OH⁻ to Compound I was 1 (1 molecule of Compound I: OH⁻ 1 mol, and this also applies to the following cases)), or 2 times (0.83 mL) the amount of Compound I. Furthermore, 2,2,3,3-tetrafluoro-1-propanol (TFP) was added to each flask so that the total volume reached 100 mL, and the mixture was sufficiently stirred to dissolve the compound. Thus, monomethine dye compositions each containing Compound I in a concentration of 20 g/L were prepared.

Subsequently, 5 mL of each solution of the monomethine dye composition prepared as described above was dripped to a 1,000-mL volumetric flask, and 2,2,3,3-tetrafluoro-1-propanol was added to the flask so that the total volume reached 1,000 mL. The mixture was sufficiently stirred, and the spectrum of the resulting solution was then measured.

Subsequently, 1 mL of each solution of the above monomethine dye composition was dripped to a glass single plate 4 centimeters square with a thickness of 0.6 mm. Spin coating was then conducted at a rotational speed of 1,500 rpm for 30 seconds, thereby, preparing a uniform H-aggregate thin film. The spectrum of the thin film of each monomethine dye composition was measured.

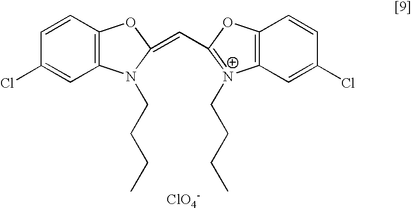

### Comparative Example 1

For comparison, a monomethine cyanine dye (Compound X) represented by formula [10] below was used (2.0 g corresponds to 3.2 mmol because the molecular weight is 629.49) as a cyanine dye compound. As in the above-described case of Compound I, a 10-% methanol solution of tetramethylammonium hydroxide was added in an amount of 0 times (without addition), 1 times (0.35 mL), or 2 times (0.70 mL) the amount of Compound X. Solutions of monomethine dye composition each containing Compound X in a concentration of 20 g/L were prepared. The above-described single plate was spin-coated with each of these solutions. The spectrum of each thin coating film was measured.

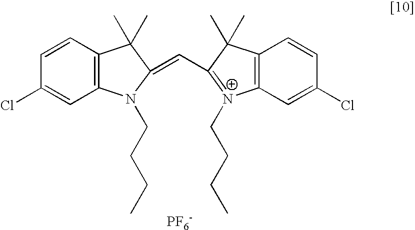

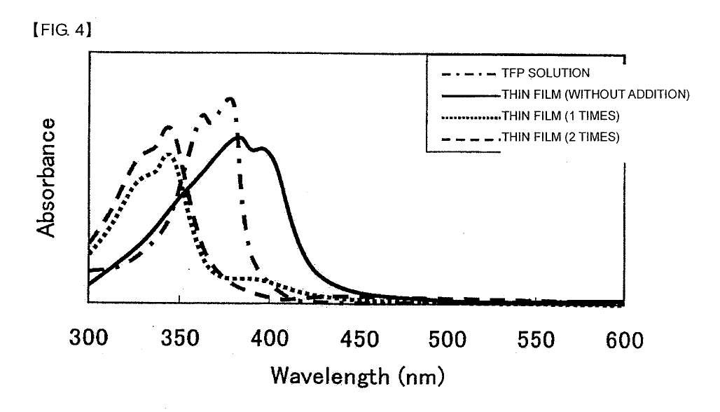

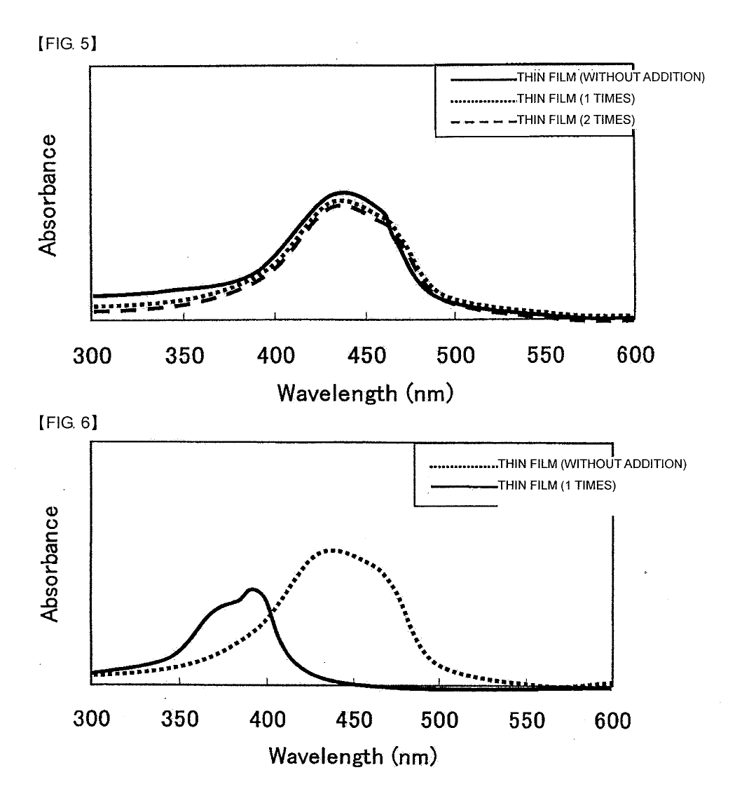

FIGS. 4 and 5 show the measurement results of the spectrum of each of the above three types of compound. In FIG. 4, regarding a peak of the absorption spectrum of each thin film formed on the single plate, a peak shown by the thick solid line (thin film (without addition of tetramethylammonium hydroxide)) was shifted to the long-wavelength side as compared with a peak of the absorption spectrum of the compound I in the solution (shown by the chain line, a TFP solution). However, the position of a peak shown by a dotted line (thin film (with addition of tetramethylammonium hydroxide in an amount 1 times the amount of Compound I)) was shifted to the short-wavelength side as compared with that shown by the thick solid line. Regarding the result shown by the long-dot line (thin film (with addition of tetramethylammonium hydroxide in an amount 2 times the amount of Compound I)), with the further addition of tetramethylammonium hydroxide, the absorption tended to be increased, the peak had a larger height, and the full width at half maximum was decreased (sharpening (decrease in the full width at half maximum)). Accordingly, it was shown that when the shapes of the spectra of the thin films related to 1 times and 2 times on the single plate were compared with that of the solution state, the peaks were shifted (by 10% or more in a typical embodiment) to the short-wavelength side. This is the feature of the H-aggregation.

In contrast, regarding the absorption spectra of Compound X on the single plate shown in FIG. 5, the position of the peak of each spectrum was not changed. The absorption shown by the dotted line (thin film (with addition of tetramethylammonium hydroxide in an amount 1 times the amount of Compound X)) and the absorption shown by the long-dotted line (thin film (with addition of tetramethylammonium hydroxide in an amount 2 times the amount of Compound X)) were somewhat smaller than that shown by the thick solid line (thin film (without addition of tetramethylammonium hydroxide)). However, a significant difference was not observed in these thin films. A shift in the position of the peak to the short-wavelength side, sharpening of the peak, or a decrease in the full width at half maximum of the peak due to the addition of tetramethylammonium hydroxide was not observed. Accordingly, these results showed that a shift in the position of the peak to the short-wavelength side, while this is the feature of the H-aggregation, was not observed.

As described above, the formation of an H-aggregate of a dye film can be checked by observing a change in the absorption spectra of a compound in a solution state and in a thin film state.

For example, the formation of the H-aggregate can be checked by the shift of the absorption peak in the thin film state to the short-wavelength side as compared with the absorption peak in the solution state.

However, the method is not limited thereto and various methods can be employed. For example, the formation of the H-aggregate can also be checked by comparing an absorption spectrum of a monomer in a solution with an absorption spectrum in the thin film state by the method described above.

As described above, in the cyanine dye thin films of Compound I (without addition of tetramethylammonium hydroxide) and Compound X, no H-aggregate was formed. Regarding the monomethine compound of Compound I, in particular, when tetramethylammonium hydroxide was added in an amount 2 times the amount of the compound, an H-aggregate was formed. By applying this composition by spin coating, a uniform H-aggregate thin film was able to be formed more easily.

### Examples 2, 3, and 4

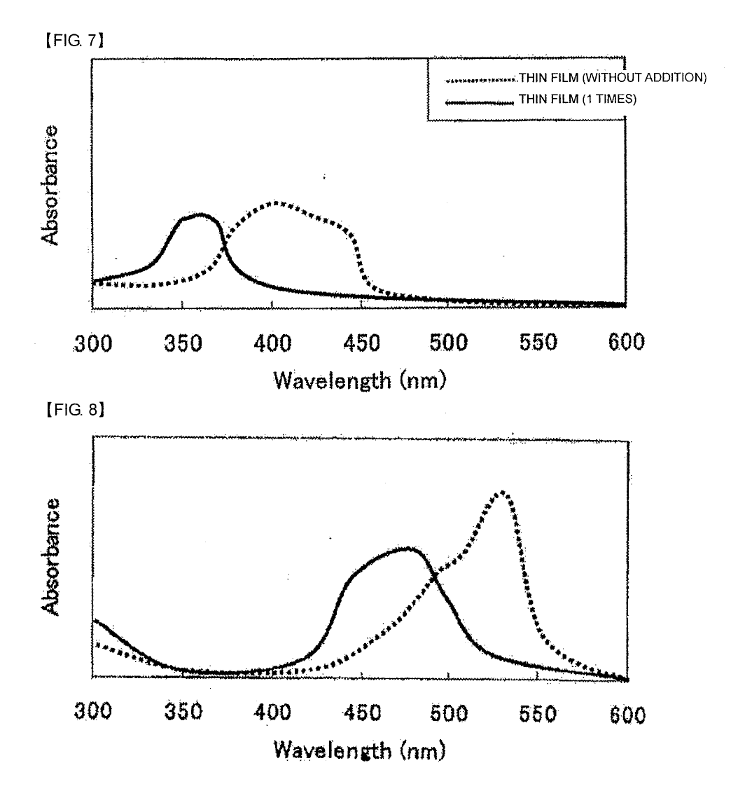

Monomethine cyanine dyes (Compounds II, III, and IV) represented by formulae [11], [12], and [13], respectively, were used instead of Compound I in Example 1. As in above-described case of Compound I, tetramethylammonium hydroxide was added in an amount of 0 times (without addition) and 1 times the amount of the compound to prepare solutions. Each of these solutions was applied on the above-described single plate by spin coating. The spectrum of each thin film of Compound II, III, or IV formed on the single plate was measured. The results thereof are shown in FIGS. 6, 7, and 8.

Regarding the absorption spectra of thin films on the single plates as shown in FIGS. 6, 7, and 8, each peak shown by the solid line (thin film (with addition of tetramethylammonium hydroxide in an amount 1 times the amount of compound)) was shifted to the short-wavelength side compared with a peak shown by a dotted line (thin film (without addition of tetramethylammonium hydroxide)). Accordingly, it was shown that the shape of the spectrum of the thin film on the single plate was shifted to the short-wavelength side. This is the feature of the H-aggregation.

Table 1 (see Example 7 described later) below shows optical properties of thin films (each formed on a single plate) of Compound II (with addition of tetramethylammonium hydroxide in an amount 1 times the amount of compound) and Compound X at a wavelength of 405 nm. The refractive index n of Compound II (with addition of tetramethylammonium hydroxide in an amount 1 times the amount of the compound) was improved by forming an H-aggregate, and thus, satisfactory optical properties were obtained.

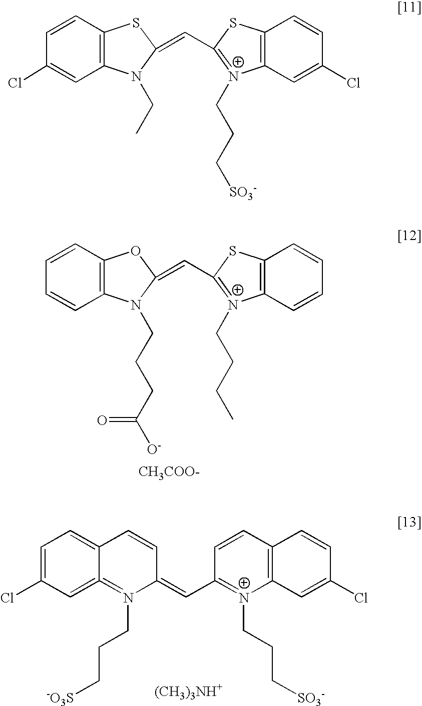

TABLE 1

| | | Recording | | |
|---|---|---|---|---|
| | n/k | sensitivity | | |
| | (405 nm) | (1x)/mW | 8T C/N dB | 2T C/N dB |
| Compound II | 2.21/0.15 | 9.5 | 53.1 | 38.6 |
| Compound X | 1.5/0.12 | 11 | 40.8 | 25.4 |

### Example 5

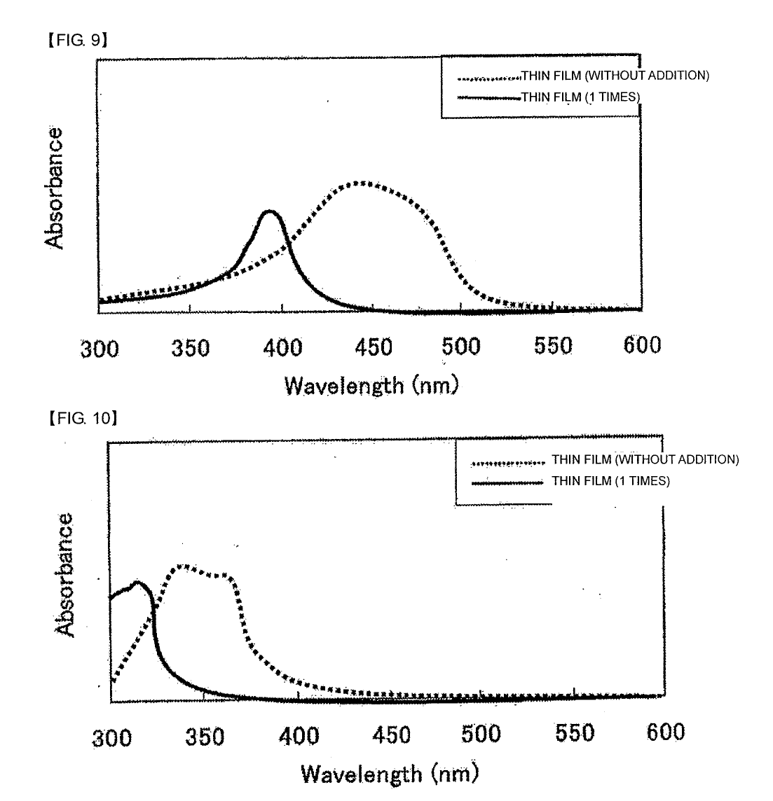

Each of thin films of monomethine dye compositions was formed (on single plates) as in example 1 except that monomethine cyanine compound (Compound V) represented by formula [14] below was used instead of Compound I and a basic compound (base) represented by formula [15] below was added in an amount of zero (without addition) or 1 times the amount of the compound instead of tetramethylammonium hydroxide in example 1. The spectrum of each thin film was measured. The results thereof are shown in FIG. 9.

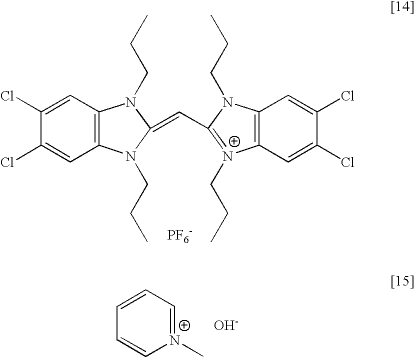

As is clear from FIG. 9, a peak shown by the solid line (thin film (with addition of the base represented by the above formula [15] in an amount 1 times the amount of the compound)) was shifted to the short-wavelength side as compared with a peak shown by a dotted line (thin film (without addition of the base represented by the above formula [15])). Accordingly, it was shown that the peak was shifted to the short-wavelength side. This is the feature of the H-aggregation.

### Example 6

Each of thin films of mono(aza)methine dye compositions was formed (on single plates) as in Example 1 except that mono(aza)methine cyanine compound (Compound VI) represented by formula [16] was used instead of Compound I and a basic compound (base) represented by formula [17] was added in an amount of zero (without addition) or 1 times the amount of the compound instead of tetramethylammonium hydroxide in Example 1. The spectrum of each thin film was measured. The results thereof are shown in FIG. 10.

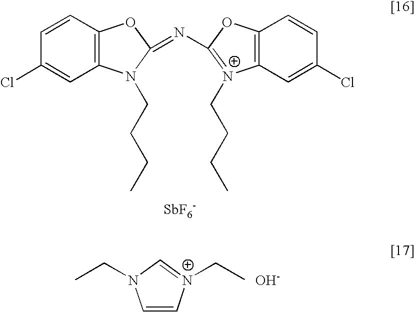

As is clear from FIG. 10, a peak shown by the solid line (thin film (with addition of the base represented by the above formula [17] in an amount 1 times the amount of the compound)) was shifted to the short-wavelength side as compared with a peak shown by a dotted line (thin film (without addition of the base represented by the above formula [17])). Accordingly, it was shown that the peak was shifted to the short-wavelength side. This is the feature of the H-aggregation.

### Example 7

A description will be made of an example in which a thin film of the monomethine dye composition (H-aggregation monomethine dye thin film) prepared by adding tetramethylammonium hydroxide and a solvent to Compound I used in Example 1 was applied to an optical recording layer 3 of an HD DVD-R disc 1.

First, 2.0 g of monomethine cyanine compound (Compound I) represented by the above formula [9] was dissolved into 100 mL of 2,2,3,3-tetrafluoro-1-propanol. Furthermore, 0.83 mL of 10-% methanol solution of tetramethylammonium hydroxide was added to the solution (in an amount of 2 times the amount of Compound I (the molar ratio of OH⁻ to 1 mole of Compound I being 2)), thus preparing a solution of Compound I having a concentration of 20 g/L. Compound VII represented by formula [18] below serving as a light stabilizer was added to the solution in an amount of 30 percent by weight. Other stabilizers of aminium base and diimonium base may also be used.

Subsequently, 1 mL of the resulting solution was applied on a disc-shaped polycarbonate substrate 2 having an outer diameter of 120 mm, a thickness of 0.6 mm, and a pregroove 7 with a pitch of 0.40 μm by a spin-coating method at a predetermined rotational speed, so that a uniform H-aggregate thin film was prepared.

The transparent substrate 2 coated with the dye was heat-treated at 80° C. for 30 minutes to volatilize the residual excess solvent and moisture, thus forming a dye surface (optical recording layer 3).

Furthermore, a light-reflecting layer 4 having a thickness of 100 nm was formed on the optical recording layer 3 by sputtering silver (Ag).

The dye spattered on the peripheral edge of the substrate 2 was removed by washing with methanol.

Furthermore, a UV curable resin adhesive SD-318 (manufactured by Dainippon Ink and Chemicals, Incorporated) was applied on the light-reflecting layer 4 by spin coating. The adhesive was then cured by irradiation of ultraviolet rays to form a protective layer 5.

A UV curable resin adhesive was applied on the surface of the protective layer 5, and a dummy substrate 6 whose material and shape (thickness: 0.6 mm, outer diameter: 120 mm) were the same as those of the substrate 2 was bonded thereto. The adhesive was then cured by irradiation of ultraviolet rays, thereby bonding the dummy substrate 6. Thus, the HD DVD-R (write-once HD DVD) disc 1 was prepared.

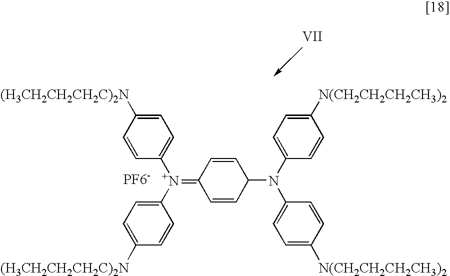

As described above, the HD DVD-R disc 1 having the optical recording layer 3 composed of a uniform thin film containing an H-aggregate of a monomethine cyanine compound was obtained using the monomethine dye composition containing Compound I and tetramethylammonium hydroxide.

In addition, an optical recording layer 3 was formed as in the above Example to prepare an HD DVD-R disc 1 except that Compound X used in Comparative example 1 was used instead of Compound I.

Table 1, as described above, also shows evaluation results of electrical properties of the HD DVD-R disc 1 (Example), which was an HD DVD-R disc prepared as in Example 7 except that Compound II was used instead of Compound I, and an HD DVD-R disc 1 (Comparative example) prepared by using Compound X. The power required for recording onto the HD DVD-R disc 1 having the optical recording layer 3 made of the monomethine dye composition containing Compound II and tetramethylammonium hydroxide was lower than that onto the HD DVD-R disc 1 prepared using Compound X. Therefore, regarding the HD DVD-R disc 1 prepared using Compound II, the recording sensitivity was more satisfactory, the C/N level in the shortest mark length was able to be improved, and symmetry during recording of random recording signals was able to be achieved with a low power.

### Example 8

An HD DVD-R (write-once HD DVD) disc 1 having an optical recording layer 3 composed of a uniform thin film containing an H-aggregate of a monoazamethine cyanine compound dye was prepared as in Example 7 except that, instead of 2.0 g of Compound I, Compound VI used in Example 6 was used in such a way that the number of moles of Compound VI was the same as that of Compound I in Example 7 and the base represented by the above formula [17] was used in an amount 1 times the amount of the compound.

Evaluation results similar to those of the HD DVD-R disc 1 prepared using Compound II, as shown in Table 1, were obtained. The power required for recording onto the HD DVD-R disc 1 having the optical recording layer 3 made of the monoazamethine dye composition containing Compound VI and the base represented by the above formula [17] was lower than that onto the HD DVD-R disc 1 prepared using Compound X. Therefore, regarding the HD DVD-R disc 1 prepared using Compound VI, the recording sensitivity was more satisfactory, the C/N level in the shortest mark length was able to be improved, and symmetry during recording of random recording signals was able to be achieved with a low power.

When Blu-ray Disc-R (write-once Blu-ray) discs 20 were prepared as in Examples 7 and 8 using each of Compounds I and VI and each of tetramethylammonium hydroxide and the compound represented by the above formula [17], evaluation results similar to those of the HD DVD-R (write-once HD DVD-R) disc 1 in Examples 7 and 8 were obtained. The same goes for the above-described other dyes.

The present application claims priority to Japanese Patent Application No. 2006-189081, filed Jul. 10, 2006, the disclosure of which is incorporated herein by reference in its entirety.

It will be understood by those of skill in the art that numerous and various modifications can be made without departing from the spirit of the present invention. Therefore, it should be clearly understood that the forms of the present invention are illustrative only and are not intended to limit the scope of the present invention.

What is claimed is:

1. An optical information recording medium comprising:
an optical recording layer onto which information is to be recorded by a laser beam,
wherein the optical recording layer includes a dye film containing a mono(aza)methine compound represented by general formula [1] and a basic compound: 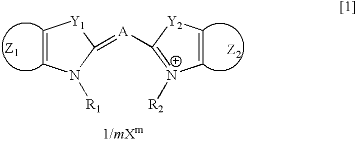
wherein Z₁ and Z₂ each represent an atomic group required for forming a five- or six-membered aromatic ring or a five- or six-membered nitrogen-containing heterocyclic ring, Z₁ and Z₂ may be the same or different, and each of Z₁ and Z₂ may independently have a substituent; Y₁ and Y₂ each represent one selected from the group consisting of O, S, N—R (wherein R represents an alkyl group of (CH₂)ₙCH₃ (wherein n represents an integer selected from 0 to 5)), and CH═CH, and Y₁ and Y₂ may be the same or different; A represents CH or N; R₁ and R₂ each represents (CH₂)ₙW (wherein n represents an integer selected from 0 to 5 and W is selected from CH₃, SO₃⁻, and COO⁻), and R₁ and R₂ may be the same or different; and 1/m X^{m} (wherein m of 1/m represents an integer selected from 1 to 4 and m of X^{m} represents the selected number of positive or negative charge) represents at least one type selected from the group consisting of an organic ion, an inorganic ion, and an organometallic ion, and 1/m X^{m} may not be contained when one of R₁ and R₂ represents (CH₂)ₙSO₃⁻ or (CH₂)ₙCOO⁻ (wherein n represents an integer selected from 0 to 5).

2. The optical information recording medium according to claim 1, wherein the mono(aza)methine compound represented by general formula [1] is a mono(aza)methine compound represented by general formula [2]: 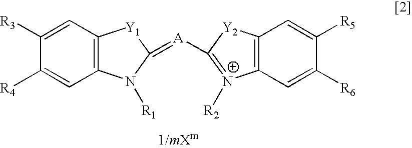
wherein Y₁ and Y₂ each represent one selected from the group consisting of O, S, N—R (wherein R represents an alkyl group of (CH₂)ₙCH₃ (wherein n represents an integer selected from 0 to 5)), and CH═CH, and Y₁ and Y₂ may be the same or different; A represents CH or N; R₁ and R₂ each represent (CH₂)ₙW (wherein n represents an integer selected from 0 to 5 and W is selected from CH₃, SO₃⁻, and COO⁻), and R₁ and R₂ may be the same or different; 1/m X^{m} (wherein m of 1/m represents an integer selected from 1 to 4 and m of X^{m} represents the selected number of positive or negative charge) represents at least one type selected from the group consisting of an organic ion, an inorganic ion, and an organometallic ion, and 1/m X^{m} may not be contained when one of R₁ and R₂ represents (CH₂)ₙSO₃⁻ or (CH₂)ₙCOO⁻ (wherein n represents an integer selected from 0 to 5); and R₃ to R₆ each represent one selected from the group consisting of a hydrogen atom, a linear or branched aliphatic hydrocarbon group, a halogenated aliphatic hydrocarbon group, a halogen atom, an ether group, an ester group, an alkylsulfamoyl group, a nitro group, a cyano group, an aromatic ring, and a heterocyclic ring, each of R₃ to R₆ may have a substituent, and R₃ to R₆ may be the same or different.

3. The optical information recording medium according to claim 1, wherein the dye film has a peak absorbance at a wavelength of 300 to 500 nm.

4. The optical information recording medium according to claim 1, wherein the dye film comprises an H-aggregate of the mono(aza)methine compound.

5. The optical information recording medium according to claim 4, wherein the dye film has a peak absorbance at a wavelength of 300 to 500 nm.

6. The optical information recording medium according to claim 2, wherein the dye film comprises an H-aggregate of the mono(aza)methine compound.

7. The optical information recording medium according to claim 1, wherein the basic compound is a hydroxide of a quaternary amine, and the molar ratio of OH⁻ to the mono(aza)methine dye is 0.2 to 3.

8. The optical information recording medium according to claim 7, wherein the dye film has a peak absorbance at a wavelength of 350 to 500 nm.

9. The optical information recording medium according to claim 6, wherein the dye film comprises an H-aggregate of the mono(aza)methine compound.

10. The optical information recording medium according to claim 1, further comprising a layer for transmittance of the laser beam therethrough wherein the dye film is provided on and in contact with a surface of the layer, said surface being opposite to a surface of the layer for the entry of the laser beam.

11. The optical information recording medium according to claim 7, wherein the hydroxide of the quaternary amine is tetraalkylammonium hydroxide.

12. The optical information recording medium according to claim 11, wherein the dye film has a peak absorbance at a wavelength of 350 to 500 nm.

13. The optical information recording medium according to claim 11, wherein the dye film comprises an H-aggregate of the mono(aza)methine compound.

14. The optical information recording medium according to claim 1, which is an HD DVD-R disc or a Blue-ray Disc-R disc.

15. A method of producing an optical information recording medium including an optical recording layer onto which information is to be recorded by a laser beam, the method comprising
applying to a layer for transmittance of the laser beam a coating solution of a mono(aza)methine dye composition containing a dye of a mono(aza)methine compound represented by general formula [1] and a basic compound by a spin-coating method to form the optical recording layer: 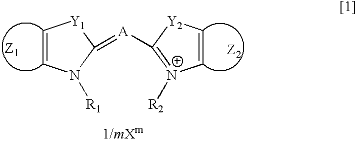
wherein Z₁ and Z₂ each represent an atomic group required for forming a five- or six-membered aromatic ring or a five- or six-membered nitrogen-containing heterocyclic ring, Z₁ and Z₂ may be the same or different, and each of Z₁ and Z₂ may independently have a substituent; Y₁ and Y₂ each represent one selected from the group consisting of O, S, N—R (wherein R represents an alkyl group of (CH₂)ₙCH₃ (wherein n represents an integer selected from 0 to 5)), and CH═CH, and Y₁ and Y₂ may be the same or different; A represents CH or N; R₁ and R₂ each represents (CH₂)ₙW (wherein n represents an integer selected from 0 to 5 and W is selected from CH₃, SO₃⁻, and COO⁻), and R₁ and R₂ may be the same or different; and 1/m X^{m} (wherein m of 1/m represents an integer selected from 1 to 4 and m of X^{m} represents a positive or negative charge of the selected number) represents at least one type selected from the group consisting of an organic ion, an inorganic ion, and an organometallic ion, and 1/m X^{m} may not be contained when one of R₁ and R₂ represents (CH₂)ₙSO₃⁻ or (CH₂)ₙCOO⁻ (wherein n represents an integer selected from 0 to 5).

16. The method of producing an optical information recording medium according to claim 15, wherein the mono(aza)methine compound represented by general formula [1] is a mono(aza)methine compound represented by general formula [2]: 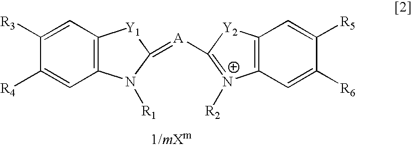
wherein Y₁ and Y₂ each represent one selected from the group consisting of O, S, N—R (wherein R represents an alkyl group of (CH₂)ₙCH₃ (wherein n represents an integer selected from 0 to 5)), and CH═CH, and Y₁ and Y₂ may be the same or different; A represents CH or N; R₁ and R₂ each represents (CH₂)ₙW (wherein n represents an integer selected from 0 to 5 and W is selected from CH₃, SO₃⁻, and COO⁻), and R₁ and R₂ may be the same or different; 1/m X^{m} (wherein m of 1/m represents an integer selected from 1 to 4 and m of X^{m} represents a positive or negative charge of the selected number) represents at least one type selected from the group consisting of an organic ion, an inorganic ion, and an organometallic ion, and 1/m X^{m} may not be contained when one of R₁ and R₂ represents (CH₂)ₙSO₃⁻ or (CH₂)ₙCOO⁻ (wherein n represents an integer selected from 0 to 5); and R₃ to R₆ each represent one selected from the group consisting of a hydrogen atom, a linear or branched aliphatic hydrocarbon group, a halogenated aliphatic hydrocarbon group, a halogen atom, an ether group, an ester group, an alkylsulfamoyl group, a nitro group, a cyano group, an aromatic ring, and a heterocyclic ring, each of R₃ to R₆ may have a substituent, and R₃ to R₆ may be the same or different.

17. The method of producing an optical information recording medium according to claim 15, wherein in the step of applying the mono(aza)methine dye, an amount of the basic compound is adjusted so as to form an H-aggregate of the mono(aza)methane dye.

18. The method of producing an optical information recording medium according to claim 15, wherein a fluorinated alcohol is used as a solvent for dissolving the mono(aza)methine compound.

19. The method of producing an optical information recording medium according to claim 15, wherein the fluorinated alcohol is 2,2,3,3-tetrafluoro-1-propanol.

20. The method of producing an optical information recording medium according to claim 15, wherein the basic compound is a hydroxide of a quaternary amine.
